(19) United States
(12) Patent Application Publication
(10) Pub. No.: US 2014/0322424 A1
(43) Pub. Date: Oct. 30, 2014

(54) Method for Producing Non-Dairy Coffee Creamer with Enhanced Milk Flavor and Taste Containing Milk or Skim Milk and Having Stability in Feathering

(71) Applicant: NAMYANG DAIRY PRODUCTS CO., LTD, Seoul (KR)

(72) Inventors: Jong Su PARK, Daejeon (KR); Hyun Soo SHIN, Daejeon (KR); Jun Pyo Hong, Daejeon (KR)

(73) Assignee: NAMYANG DAIRY PRODUCTS CO., LTD, Seoul (KR)

(21) Appl. No.: 13/873,312

(22) Filed: Apr. 30, 2013

(51) Int. Cl. A23C 11/04

(52) U.S. Cl. CPC A23C 11/045
USPC 426/585; 426/580; 426/595

(57) ABSTRACT

A method of producing non-dairy coffee creamer, includes a sterilizing process (process 1) for sterilizing milk or skim milk, a cooling process for cooling the sterilized milk obtained from process 1 (process 2), a vacuum evaporating process for pre-heating and then vacuum evaporating the cooled milk obtained from process 2 (process 3), a mixing and homogenizing process for mixing and homogenizing the evaporated milk obtained from process 3, a source material for non-dairy coffee creamer, a milk protein concentrate powder and a milk calcium under atmospheric pressure or vacuum pressure (process 4), and a drying process for drying the homogenized mixture obtained from process 4 (process 5), and a non-dairy coffee creamer produced by using the method.

### BACKGROUND

1. Technical Field

The present invention relates to a method of producing non-dairy coffee creamer.

2. Description of the Related Art

Milk or evaporated milk (sweetened or non-sweetened) is added to coffee to soften the flavor and taste of coffee and provide whitening to coffee, and due to inconveniences for preserving and portability of liquid products, a non-dairy coffee creamer, which is a powder product, is commercialized for use.

However, since the non-dairy coffee creamer consists of 30 to 35 wt % of non-dairy vegetable hardened fat, 2 to 5 wt % of a protein, such as casein or sodium caseinate, carbohydrate, an emulsifier, and about 60 wt % of an acidity controller, the non-dairy coffee creamer does not provide sufficient flavor and taste of milk.

To embody sufficient milk flavor and taste, milk or skim milk must be used. However, due to a heat treatment performed in the formation process into powder, the structure of milk protein is changed, or a constituent protein of casein micelle decomposes and dissociates, thereby decreasing stability of hydration and micelle stability to form a complex of casein and thermal denaturalizable whey protein and thus, solidification sedimentation occurs. In addition, thermal denaturalization and solidification is promoted due to a reaction of decomposed calcium and a protein, and is a major cause for feathering of non-dairy coffee creamer that uses milk or skim milk.

Casein or sodium caseinate is added as a protein of non-dairy coffee creamer, is a milk protein, provides a milk flavor and taste, and maintains stability of micro fat spherical particles during a homogenizing or drying process.

Excellent non-dairy coffee creamer is first required to have stability during mixing with hot coffee, and softening of flavor and taste of coffee is also an important factor. Since a non-dairy coffee creamer that contains casein or sodium caseinate has a particular off-flavor, organoleptic properties thereof, which are associated with the softening of the flavor and taste of coffee, decrease, compared to a non-dairy coffee creamer that uses milk or skim milk.

Also, milk or skim milk may cause off-taste and off-flavor due to barny flavor, feedy flavor, and short-chain fatty acid. Components of the off-taste and the off-flavor are volatile short-chain compounds, and they do not evaporate during an indirect sterilizing method of sterilizing in a closed space, of which example are a plate type method or a tubular type method, and they chemically react with other components. Accordingly, such off-taste and off-flavor components act as a major factor in decreasing a pure milk taste.

Accordingly, when milk or skim milk is used in preparing non-dairy coffee creamer, required are excellent stability in feathering during mixing with hot coffee, and minimizing off-taste and off-flavor components after the sterilization to balance various organoleptic properties (milk flavor and taste, sweet taste, softness, aromatic flavor, easy-to-swallow, end taste, or the like) of milk or skim milk.

Conventionally, various methods for improving stability in feathering of non-dairy coffee creamer and organoleptic properties of non-dairy coffee creamer have been developed. Korean Patent No. 10-0133586 discloses a coffee cream composition with stability in feathering, wherein the coffee cream composition includes a casein protein, 1.5 to 2.5 wt % of diphosphate, and 0.2 to 0.6 wt % of tripolyphosphate. Korean Patent No. 10-0647057 discloses that an aqueous coffee flavor component and a soluble coffee solid are mixed with creamer powder to provide a soluble creamer power with enhanced flavor, and according to this disclosure, coffee flavor is captured inside coffee oil to enhance the flavor and taste of coffee. Korean Patent Publication No. 2007-0069176 discloses a composition including a sufficient amount of a debittering agent to reduce or block negative flavor and taste characteristics of beverages with creamer. In addition, Japanese Patent Publication No. 2005-73527 discloses powdered cream prevented from feathering, formulated with heat-processed (135° C., 30 seconds or more) skimmed milk presenting the F value of ≧12 as a heat hysteresis index and containing ≧0.3 mass % of lactulose, followed by drying, and a method for producing the powdered cream.

However, although the non-dairy coffee creamers disclosed above improves stability in, for example, feathering, the flavor and taste of coffee or soft taste, casein or sodium caseinate, phosphate, artificial flavoring agent, and a debittering agent, which are used in preparing the non-dairy coffee creamer, are harmful for the human body, and such non-dairy coffee creamers may have poorer flavor and taste of coffee than a non-dairy coffee creamer containing milk or skim milk. In addition, the casein or sodium caseinate added as a protein of a non-dairy coffee creamer is an expensive milk protein, and due to costs resulting from a long-time high temperature process, manufacturing costs may increase, and the use of casein or sodium caseinate is inefficient in consideration of milk flavor and taste enhancement effects.

In addition, non-dairy coffee creamer containing casein or sodium caseinate has a distinctive off-flavor of casein, and milk exposed to high temperature for a long period of time may form a sulfur compound called a heated smell and thus, the fresh taste of the milk may degrade. A representative aromatic component of the sulfur compound is dimethyl sulfide, and this component may substantially affect a decrease in the taste and flavor of sterilized milk product, and the generation of dimethylsulfide, which occurs during a sterilizing process, needs to be suppressed as much as possible so as to maintain organoleptic characteristics associated with softening of the flavor and taste of coffee.

### SUMMARY

An aspect of the present invention provides a method of producing a non-dairy coffee creamer. According to the method, to prevent feathering, which shows undesired appearance due to denaturalization of milk protein of milk or skim milk as a source material for non-dairy coffee creamer, a milk protein concentrate powder and a milk calcium is included as a milk protein. Therefore, high stability in feathering may be obtained. In addition, milk or skim milk is sterilized and then vacuum evaporated to remove components of off-taste and off-flavor, and the evaporated milk is mixed with a source material for non-dairy coffee creamer under vacuum pressure in preparing non-dairy coffee creamer and the mixture is homogenized. By doing so, foreign tastes of non-dairy coffee creamer are removed, and the non-dairy coffee creamer produced as described above has an enhanced soft taste of milk.

An aspect of the present invention provides a method of producing non-dairy coffee creamer that contains milk or skim milk and has stability in feathering, wherein the non-dairy coffee creamer contains non-dairy fat and oil, carbohydrate, a protein, and phosphate, and the protein includes milk or skim milk, a milk protein concentrate powder and a milk calcium other than casein or sodium caseinate.

In the method of producing non-dairy coffee creamer, when non-dairy coffee creamer is prepared using both a milk protein concentrate powder and a milk calcium, feathering of non-dairy coffee creamer occurring due to milk or skim milk used instead of casein or sodium caseinate may be effectively suppressed.

In addition, in the method of producing non-dairy coffee creamer, according to another embodiment of the present invention, the non-dairy coffee creamer contains a milk protein concentrate powder and a milk calcium, and one or more of milk and skim milk.

The method of producing non-dairy coffee creamer according to an embodiment of the present invention includes: sterilizing milk or skim milk; cooling the sterilized milk to obtain a cooled sterilized milk; pre-heating and then vacuum-evaporating the cooled sterilized milk to obtain an evaporated milk; mixing and homogenizing the evaporated milk, a source material for non-dairy coffee creamer, a milk protein concentrate powder and a milk calcium under atmospheric pressure or vacuum pressure to obtain a homogenized mixture; and drying the homogenized mixture to produce the non-dairy coffee creamer.

The preheating may be performed at a temperature of 80 to 90° C. and the vacuum-evaporating may be performed at a vacuum pressure of −0.7 to −0.9 bar until a dissolved oxygen concentration is 1.0 to 1.6 ppm.

The mixing and homogenizing may be performed by pre-heating the evaporated milk to a temperature of 40 to 70° C., and then mixing and homogenizing the source material for non-dairy coffee creamer, the milk protein concentrate powder and the milk calcium at a vacuum pressure of −0.3 to −0.7 bar.

The source material for non-dairy coffee creamer may be selected from the group consisting of glucide, non-dairy fat and oil, an emulsifier, an acidity controller, and a combination thereof.

The milk protein concentrate powder in the homogenized mixture may be in a range of 1 to 6 wt %, based on total weight of the homogenized mixture.

The milk calcium in the homogenized mixture may be in a range of 0.3 to 1.5 wt %, based on total weight of the homogenized mixture.

The milk calcium in the homogenized mixture may be greater than 0.5 wt %, based on total weight of the homogenized mixture.

The mixing and homogenizing may be performed by mixing and homogenizing 4 to 5 wt % of pre-heated evaporated milk, 55 to 55.5 wt % of starch syrup, 31 to 32 wt % of non-dairy fat and oil, 1.5 wt % of emulsifier, 2.5 wt % of phosphate, 4 wt % of milk protein concentrate powder, and 0.5 to 1.0 wt % of milk calcium.

The homogenized mixture is essentially free from casein or sodium caseinate.

A non-dairy coffee creamer may be prepared by using the above method.

A instant coffee mix package may include coffee, sugar, and the non-dairy coffee creamer prepared by using the above method.

### BRIEF DESCRIPTION OF THE DRAWINGS

FIG. 1 is a flowchart schematically illustrating a method of producing non-dairy coffee creamer according to an embodiment of the present invention.

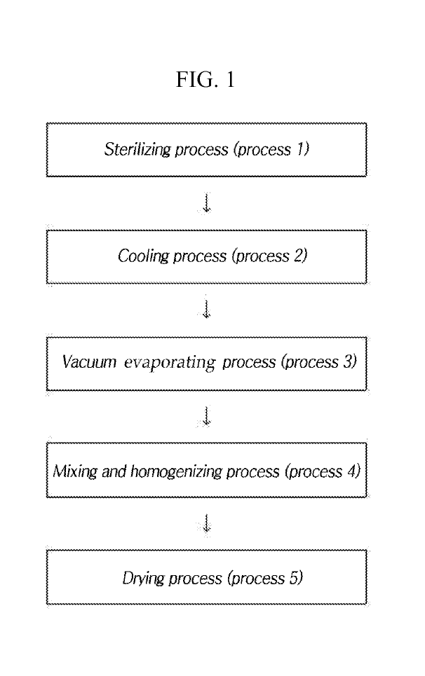

FIG. 2 shows sensory evaluation results of non-dairy coffee creamer produced according to Treatment group 1, Treatment group 2 and Control.

### DETAILED DESCRIPTION

Hereinafter, in connection to the attached drawings, a method of producing non-dairy coffee creamer according to an embodiment of the present invention is described in detail.

The method of producing non-dairy coffee creamer according to an embodiment of the present invention includes:

a sterilizing process (process 1) for sterilizing milk or skim milk;

a cooling process for cooling the sterilized milk obtained from process 1 (process 2);

a vacuum evaporating process for pre-heating and then vacuum evaporating the cooled milk obtained from process 2 (process 3);

a mixing and homogenizing process for mixing and homogenizing the evaporated milk obtained from process 3, a source material for non-dairy coffee creamer, a milk protein concentrate powder and a milk calcium (process 4); and

a drying process for drying the homogenized mixture obtained from process 4 (process 5).

1. Sterilizing Process (process 1)

This process is a process for sterilizing milk or skim milk to destroy microorganisms harmful for the human body. An available sterilizing method used herein may be any one of various typical milk sterilizing methods, and detailed examples of the sterilizing method are a low-temperature long-time sterilizing method (at a temperature of 63 to 65° C. for 30 minutes), a high-temperature short-time sterilizing method (at a temperature of 72 to 75° C. for 15 seconds to 20 seconds), and a ultra high temperature rapid treatment method (at a temperature of 130 to 150° C. for 0.5 seconds to 5 seconds). Milk or skim milk that has been subjected to a sterilizing process will be referred to as sterilized milk.

2. Cooling Process (Process 2)

This process is a process for cooling the sterilized milk, and is performed by cooling the sterilized milk obtained form process 1 to a temperature of 10° C. or lower. The cooling of the sterilized milk to a temperature of 10° C. or lower is to suppress the growth of microorganisms and maintain a sanitary state. Sterilized milk that has been subjected to a cooling process will be referred to as cooled milk.

3. Vacuum Evaporating Process (Process 3)

This process is a process for pre-heating and then vacuum evaporating the cooled milk, and is performed by pre-heating the cooled milk obtained from process 2 to a temperature of 80 to 90° C. and then vacuum evaporating using a vacuum evaporating device until a concentration of dissolved oxygen is in a range of 1.0 to 1.6 ppm. Regarding the vacuum evaporating of the cooled milk, the pre-heating may be performed at a temperature of 80 to 90° C., and when the temperature is lower than 80° C., the removal effects of off-taste or off-flavor of cooled milk may be insufficient, and when the temperature is higher than 90° C., even a unique flavor and taste of milk may be removed. In addition, a vacuum pressure may be in a range of −0.7 to −0.9 bar in consideration of the fresh taste and flavor and taste of milk and the removal of microbubbles and residual components of off-taste and off-flavor. Cooled milk that has been subjected to a vacuum evaporating process will be referred to as evaporated milk.

4. Mixing and Homogenizing Process (Process 4)

This process is a process for mixing and homogenizing the evaporated milk, a source material for non-dairy coffee creamer, a milk protein concentrate powder and a milk calcium under atmospheric pressure or vacuum pressure. Milk protein concentrate (MPC) is any type of concentrated milk product that contains 40-90% milk protein. For example, the evaporated milk obtained from process 3 is preheated to a temperature of 40 to 70° C., and then at a vacuum pressure of −0.3 to −0.7 bar, the evaporated milk is mixed with a source material for non-dairy coffee creamer, a milk protein concentrate powder and a milk calcium and the mixture is homogenized.

As a source material for non-dairy coffee creamer used in this process, any one of various materials that are typically used in preparing non-dairy coffee creamer may be used. Such source materials for non-dairy coffee creamer and appropriate amounts thereof are well known in the art. The source material for non-dairy coffee creamer may be at least one selected from glucide, non-dairy fat and oil, an emulsifier, and an acidity controller, but is not limited thereto.

A temperature for the preheating of evaporated milk may be in a range of 40 to 70° C. When the preheating temperature is lower than 40° C., many microbubbles may occur during the mixing of the evaporated milk, the source material for non-dairy coffee creamer, the milk protein concentrate powder and the milk calcium and thus, the flavor and taste of milk may degrade. When the preheating temperature is higher than 70° C., the heating is not economical because it does not contribute to an increase in effects. Also, the vacuum pressure may be in a range of −0.3 to −0.7 bar so as to improve the flavor and taste of milk while removing microbubbles and residual components of the off-taste and off-flavor.

The resulting solution obtained by mixing and homogenizing the evaporated milk and components of non-dairy coffee creamer is referred to as a homogenized mixture.

An amount of the milk protein concentrate powder in the homogenized mixture may be in a range of 1 to 6 wt %, and for example, 2 to 5 wt %, and may be, for example, 4 wt %.

An amount of the milk calcium in the homogenized mixture may be in a range of 0.3 to 1.5 wt %, and for example, 0.4 to 1.2 wt %, and may be, for example, 0.5 to 1.0 wt %.

5. Drying Process (Process 5)

This process is a process for drying the homogenized mixture, and is performed by drying the homogenized mixture obtained from process 4 by using a dryer.

In this regard, a blasting temperature may be set in a range of 130 to 160° C., and when the blasting temperature is lower than 130° C., the drying time may be prolonged according to a decrease in drying amount, which is not economical. On the other hand, when the drying time is higher than 160° C., a formation rate of microparticles according to an increase in drying amount may increase.

Hereinafter, reference will now be made in detail to examples of the present invention. However, the following examples are presented herein for illustrative purpose only, and do not limit the scope of the present invention. That is, simply changing of the present invention is obvious to one of ordinary skill in the art, and such changes are all included in the scope of the present invention.

### Example 1

### Determination of Conditions for Producing Non-Dairy Coffee Creamer with Enhanced Flavor and Taste of Milk Containing Milk or Skim Milk

To determine optimized production conditions for non-dairy coffee creamer with enhanced flavor and taste of milk containing milk or skim milk, non-dairy coffee creamer was produced by using different vacuum evaporating processes and mixing and homogenizing processes.

Treatment Group 1: Non-Dairy Coffee Creamer Produced Using Milk

Milk was sterilized (at a temperature of 130 to 150° C. for 0.5 seconds to 5 seconds), and then cooled to a temperature of 10° C. or lower. The cooled milk was pre-heated to a temperature of 90° C. and then vacuum evaporated with a vacuum pressure of −0.9 bar until a concentration of dissolved oxygen was 1.0 ppm. The evaporated milk was pre-heated to a temperature of 70° C., and then at a vacuum pressure of −0.5 bar, the pre-heated evaporated milk, starch syrup, non-dairy vegetable hardened fat, casein or sodium caseinate, an emulsifier, and acidity controller were mixed and homogenized to prepare a homogenized mixture. The prepared homogenized mixture was dried by using a dryer with a blasting temperature of 150° C. to complete the production of non-dairy coffee creamer.

Treatment Group 2: Non-Dairy Coffee Creamer Produced Using Skim Milk

Skim milk was sterilized (at a temperature of 130 to 150° C. for 0.5 seconds to 5 seconds), and then cooled to a temperature of 10° C. or lower. The cooled skim milk was pre-heated to a temperature of 90° C. and then vacuum evaporated with a vacuum pressure of −0.9 bar until a concentration of dissolved oxygen was 1.0 ppm. The evaporated milk was pre-heated to a temperature of 70° C., and then at a vacuum pressure of −0.5 bar, the pre-heated evaporated milk, starch syrup, non-dairy vegetable hardened fat, casein or sodium caseinate, an emulsifier, and acidity controller were mixed and homogenized to prepare a homogenized mixture. The prepared homogenized mixture was dried by using a dryer with a blasting temperature of 150° C. to complete the production of non-dairy coffee creamer.

Control: Typical Non-Dairy Coffee Creamer

Starch syrup, non-dairy vegetable hardened fat, casein or sodium caseinate, an emulsifier, and acidity controller were mixed and homogenized at a temperature of 65° C., and then, the mixture was dried by using a dryer with a blasting temperature of 150° C. to produce non-dairy coffee creamer.

### Experimental Example 1

### Optimal Conditions of Vacuum Evaporating Process and Sensory Evaluation

To optimize conditions for the vacuum evaporating process, sterilized milk with a dissolved oxygen concentration of 5 ppm or lower and sterilized skim milk with a dissolved oxygen concentration of 5 ppm or lower were each pre-heated to a temperature of 90° C., and then, a vacuum pressure was adjusted to be in a range of −0.09 to −1.0 bar and a vacuum evaporating process was performed thereon. Dissolved oxygen concentrations of milk and skim milk according to a vacuum pressure were identified and the presence of microbubbles was identified through a microscope, and corresponding sensory evaluations were performed with a professional panel consisting of 50 members. Results thereof are shown in Table 1 below.

TABLE 1
Optimal conditions of vacuum evaporating
process and sensory evaluation

| | | Dissolved | | |
|---|---|---|---|---|
| | Vacuum | oxygen | | |
| | pressure | concentration | Microbubbles | Sensory |
| | (bar) | (ppm) | ¹⁾ | evaluation ²⁾ |
| Milk | −0.09 | 4.8 | + | ⋄ |
| | −0.1 | 4.0 | − | ⋄ |
| | −0.3 | 2.0 | − | ⋄ |
| | −0.5 | 2.0 | − | ⋄ |
| | −0.7 | 1.6 | − | ⊚ |
| | −0.9 | 1.0 | − | ⊚ |
| Skim milk | −0.09 | 4.6 | + | ⋄ |
| | −0.1 | 4.1 | − | ⋄ |
| | −0.3 | 2.0 | − | ⋄ |
| | −0.5 | 1.9 | − | ⋄ |
| | −0.7 | 1.5 | − | ⊚ |
| | −0.9 | 1.0 | − | ⊚ |

¹⁾ −: no microbubbles, ±: a few microbubbles, +: many microbubbles
²⁾ ⊚: fresh taste of evaporated milk ⋄: poor flavor and taste of evaporated milk

As shown in Table 1, when the vacuum pressure applied to the milk or skim milk increases, a dissolved oxygen concentration decreases, and when the vacuum pressure is −0.9 bar, the dissolved oxygen concentration was decreased up to the lowest value 1.0 ppm, and from microscope test results, it was confirmed that when the vacuum pressure is −0.1 bar or more, microbubbles were completely removed. In addition, sensory evaluation results show that when the vacuum pressure is in a range of −0.7 bar to −0.9 bar, the fresh taste of evaporated milk and the flavor and taste of milk were sufficiently obtained. The test results of dissolved oxygen concentration, microbubbles, and organoleptic properties show that an optimal vacuum pressure that minimizes a dissolved oxygen concentration of milk or skim milk, removes microbubbles, and improves the flavor and taste of the evaporated milk is in a range of −0.7 bar to −0.9 bar.

### Experimental Example 2

### Optimal Condition Tests for Mixing and Homogenizing Process

To optimize pre-heating temperature conditions and vacuum pressure conditions of a mixing and homogenizing process, each of milk and skim milk was sterilized by using a low-temperature long-time sterilizing method (at a temperature of 63 to 65° C. for 30 minutes) and then pre-heated to a temperature of 90° C., and a vacuum pressure was adjusted to be −0.9 bar, and a vacuum evaporating process was performed thereon. Then, the evaporated milk was pre-heated to a temperature of 40 to 70° C., and then at a vacuum pressure of −0.1 to −0.9 bar, the pre-heated evaporated milk and a source material for non-dairy coffee creamer were mixed and homogenized to prepare a homogenized mixture. A dissolved oxygen concentration of the homogenized mixture according to a pre-heating temperature of the evaporated milk and the vacuum pressure was measured and the presence of microbubbles was confirmed using a microscope. Results thereof are shown in Table 2 below.

TABLE 2
Optimal condition tests for mixing and homogenizing process

| Vacuum pressure (bar)\ | Dissolved oxygen concentration | | | |
|---|---|---|---|---|
| pre-heating | (ppm)/microbubbles¹⁾ | | | |
| temperature (° C.) | 40° C. | 50° C. | 60° C. | 70° C. |
| −0.1 | 5.1/+ | 4.8/+ | 4.2/− | 4.0/− |
| −0.3 | 4.2/− | 4.0/− | 2.8/− | 2.0/− |
| −0.5 | 3.8/− | 3.6/− | 2.5/− | 2.0/− |
| −0.7 | 3.0/− | 3.0/− | 2.0/− | 1.6/− |
| −0.9 | 2.5/± | 2.1/± | 1.7/± | 1.0/± |

¹⁾−: no microbubbles, ±: a few microbubbles, +: many microbubbles

As shown in Table 2, when the pre-heating temperature of the evaporated milk and the vacuum pressure applied in the manufacturing procedure for the homogenized mixture are high, the dissolved oxygen concentration decreases and when the vacuum pressure is −0.9 bar, the dissolved oxygen concentration was decreased up to the lowest value 1.0 ppm, and from microscope test results, it was confirmed that microbubbles were completely removed when the vacuum pressure of −0.3 to −0.7 bar was applied after heating to a temperature of 40° C. or 50° C., or when the vacuum pressure of −0.1 to −0.7 bar as applied after heating to a temperature of 60° C. or 70° C.

The dissolved oxygen concentration of the homogenized mixture according to an embodiment of the pre-heating temperature of the evaporated milk and the vacuum pressure was measured and microbubbles tests were performed. Test result thereof show that an optimal pre-heating temperature of the evaporated milk to completely remove microbubbles while minimizing the dissolved oxygen amount was in a range of 40 to 70° C., and a vacuum pressure was in a range of −0.3 bar to −0.7 bar.

### Experimental Example 3

### Sensory Evaluation and Dimethyl Sulfide Content Analysis

Non-dairy coffee creamers (Treatment groups 1 and 2) and non-dairy coffee creamers (Control) produced by using a typical non-dairy coffee creamer production method were individually dissolved in an amount of 5 wt % in water at a temperature of 85° C. to perform sensory evaluations and dimethyl sulfide content analysis.

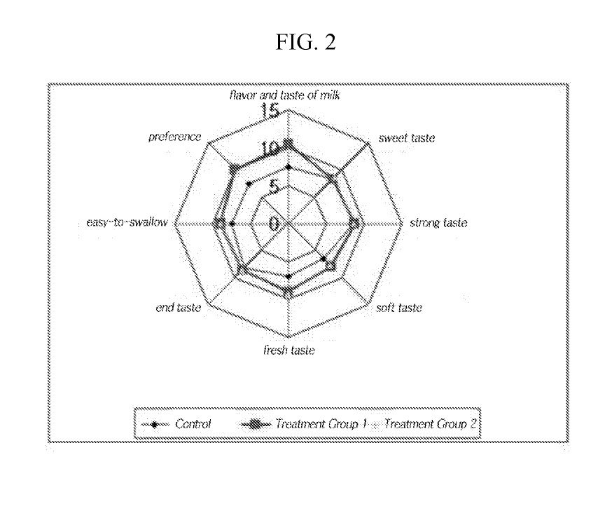

15 members of specialist panel having an excellent taste sense were picked and informed of definitions of description items of non-dairy coffee creamer taste, and the panel members were trained regarding the respective description items in various intensity phases, and finally, 10 members were chosen from the 15 members, and evaluation results of the respective description items were represented as a length drawn on a 15 cm line, and an average of the length was used to perform a quantitative description analysis, and at the same time, an aromatic dimethyl sulfide content (ppb) analysis was performed by head space analysis. Results thereof are shown in Table 3 and FIG. 2.

TABLE 3
Sensory evaluation and dimethyl sulfide content

| | Milk | | | | | | | | Dimethyl |
|---|---|---|---|---|---|---|---|---|---|
| | flavor | | | | | | | | sulfide |
| | and | Sweet | Strong | Soft | Fresh | End | Easy-to- | | content |
| | taste | taste | taste | taste | taste | taste | swallow | Preference | (ppb) |
| Treatment | 10.5 | 8.4 | 8.7 | 8.0 | 9.0 | 8.8 | 9.0 | 10.0 | 10 |
| group 1 | | | | | | | | | |
| Treatment | 9.8 | 8.6 | 8.6 | 7.8 | 9.2 | 8.6 | 9.0 | 9.6 | 9 |
| group 2 | | | | | | | | | |
| Control | 7.5 | 8.3 | 8.6 | 6.5 | 7.0 | 8.4 | 7.5 | 7.5 | 79 |

Referring to Table 3 and FIG. 2, regarding all items for sensory evaluations, Treatment groups 1 and 2 obtained higher scores than Control. This result shows that due to the use of evaporated milk obtained by sterilizing milk or skim milk and vacuum evaporating the milk to remove components of off-taste and off-flavor therefrom, the flavor and taste of milk and the fresh taste of milk are enhanced, and since the evaporated milk and the source material for non-dairy coffee creamer are mixed and homogenized at a vacuum pressure in producing non-dairy coffee creamer, foreign tastes of non-dairy coffee creamer are removed, and the obtained non-dairy coffee creamer is easy-to-swallow and has a soft taste, and thus, the overall taste of the non-dairy coffee creamer is improved.

Also, this test result that the dimethyl sulfide contents of Treatment groups 1 and 2 are lower than that of Control is due to the fact that in the mixing and homogenizing process, the evaporated milk is pre-heated at an optimal temperature and the pre-heated evaporated milk is mixed with a source material for non-dairy coffee creamer and the mixture is homogenized at an optimal vacuum pressure so as to minimize a dissolved oxygen concentration of the homogenized mixture and to completely remove microbubbles.

However, a non-dairy coffee creamer prepared as described above contains casein or sodium caseinate as a protein source, and the casein or sodium caseinate is harmful for the human body, and has a distinctive off-flavor of casein. Accordingly, a protein that is a replacement for casein or sodium caseinate is needed, and to this end, an experiment was performed in the same production process for non-dairy coffee creamer as used in Example 1, and a milk protein concentrate powder and a milk calcium, a replacement for casein or sodium caseinate, with stability in feathering obtained according to Examples 2 to 4 was used. In the specification and the claims, the non-dairy coffee creamer or the homogenized mixture being “essentially free of casein or sodium caseinate” means that the casein or sodium caseinate are not additionally added to the mixture of the evaporated milk, the source material for non-dairy coffee creamer, the milk protein concentrate powder and the milk calcium in the mixing and homogenizing process.

### Example 2

### pH, and Buffer Capacity of Milk Protein and Source Material for Milk

a. pH, and buffer capacity of milk protein and source material for milk are shown in Table 4 below. The buffer capacity is indicated as ml of a sulfuric acid consumed until a pH of a 5% aqueous solution is changed to 4.6 by addition of 0.1N H₂SO₄ thereto, and the higher buffer capacity is, the lesser sensitivity to a pH change and the lower feathering rate.
b.

TABLE 4
c. pH, and buffer capacity of milk protein and source material for milk

| | Kind of milk protein and source | | | | | | |
|---|---|---|---|---|---|---|---|
| | material for milk | | | | | | |
| | Casein | Milk | | | | | |
| | or | (whole | Skim | Evaporated | Milk protein | | |
| | Sodium | milk | milk | whey | concentrate | | Milk |
| | caseinate | powder) | (powder) | protein | powder | Lactose | calcium |
| pH | 6.7 | 6.5 | 6.6 | 6.4 | 6.8 | 5.6 | 7.2 |
| Buffer | 20~25 | 20~25 | 25~30 | 15~20 | 30~35 | 0.1~1.0 | 270~310 |
| capacity | | | | | | | |
| (ml) | | | | | | | |

As shown in Table 4, when spray-dried whole milk powder or skim milk powder was used, a protein included therein was denatured by heat. Accordingly, when they were added to a coffee solution with a low pH, feathering occurred seriously. When a milk protein concentrate powder with relatively high buffer capacity was used, thermal stability of whey protein from among milk protein contained therein was further lowered when hot water was added, leading to a higher likelihood of feathering. In addition, the feathering is promoted by a reaction between decomposed calcium and a protein. Also, the lactose had very low buffer capacity, but the milk calcium which has good thermostability had relatively high pH and buffer capacity, and thus it is assumed that feathering rate may be low.

### Example 3

### pH, Buffer Capacity and Feathering Rate of Non-Dairy Coffee Creamers Produced Using Different Milk Proteins

pH, buffer capacity and feathering rate of non-dairy coffee creamers produced using different milk proteins were measured. Composition ratios of Preparation Example 1 to Preparation Example 4 and results thereof are shown below (see Table 5). A coconut hardened oil was used as a non-dairy fat and oil, and glycerin esters of fatty acid was used as an emulsifier.

The feathering rate was evaluated by adding 5 g of the non-dairy coffee creamer produced and 1.5 g of instant coffee to 100 ml of hot water at a temperature of 85° C. or more, and when the feathering rate is evaluated as 1, this evaluation result means that feathering does not occur; when the feathering rate is evaluated as 2, this evaluation result means that feathering slightly occur; when the feathering rate is evaluated as 3, this evaluation result means that feathering occurs moderately, and when the feathering rate is evaluated as 4, this evaluation result means that feathering occurs seriously. In the related art, typically, it is assumed that the levels of feathering 1 or 2 are commercializable levels.

TABLE 5
pH, buffer capacity, and feathering rate of non-dairy
coffee creamers produced using various milk proteins

| | | | | | |
|---|---|---|---|---|---|
| | Control | Preparation | Preparation | Preparation | Preparation |
| | Casein or | Example 1 | Example 2 | Example 3 | Example 4 |
| Kind of | Sodium | Milk (whole | Skim milk | Evaporated | Milk protein |
| protein | caseinate | milk powder) | (powder) | whey protein | concentrate powder |

Composition ratio (wt %)

| | | | | | |
|---|---|---|---|---|---|
| Glucide | 60.5 | 53.8 | 54.0 | 60.0 | 60.0 |
| (low DE | | | | | |
| glucide starch | | | | | |
| syrup) | | | | | |
| Non-dairy fat | 32.0 | 28.6 | 32.0 | 32.0 | 32.0 |
| and oil | | | | | |
| Protein | 3.5 | 13.6 | 10.0 | 4.0 | 4.0 |
| Emulsifier | 1.5 | 1.5 | 1.5 | 1.5 | 1.5 |
| Phosphate | 2.5 | 2.5 | 2.5 | 2.5 | 2.5 |

pH, buffer capacity, and feathering rate

| | | | | | |
|---|---|---|---|---|---|
| pH | 8.0 | 7.6 | 7.8 | 7.4 | 7.9 |
| Buffer | 9.2 | 8.4 | 8.5 | 8.1 | 8.6 |
| capacity | | | | | |
| (ml) | | | | | |
| Feathering | 1 | 4 | 4 | 4 | 4 |
| rate | | | | | |

As shown in Table 5, when non-dairy coffee creamer was produced by using milk protein with an amount that is similar to that (about 3 g wt %) of casein or sodium caseinate, Preparation Example 1 to Preparation Example 4 in Table 4 showed identical feathering rates.

### Example 4

### pH, Buffer Capacity, and Feathering Rate of Non-Dairy Coffee Creamer with Varying Milk Calcium Content

A milk protein concentrate powder and a milk calcium which have the highest pH and buffer capacity in Table 4 are each selected and then used as a milk protein and a source material for milk capable of replacing casein or sodium caseinate. Non-dairy coffee creamers having a composition ratio of typical non-dairy coffee creamer, milk or skim milk, and varying milk calcium content were obtained by treating components of Preparation Example 5 to Preparation Example 12 as described below, and pH, buffer capacity and feathering rate thereof were measured.

A milk calcium used in embodiments of the present invention was prepared by membrane separation method from a skim milk, and comprised of approximately 20 weight % or more of calcium, approximately 10 weight % or more of phosphorus, and approximately 70 weight % or more of inorganic matter other than calcium and phosphorus, based on the total weight of the milk calcium. Composition ratios of Preparation Examples 5 to 12 and measurement results thereof are shown in below (referring to Tables 6 and 7).

TABLE 6
pH, buffer capacity, feathering rate and flavor and taste of milk of milk-containing
non-dairy coffee creamer with varying milk calcium content

| | | | | | |
|---|---|---|---|---|---|
| | Comparative | Preparation | Preparation | Preparation | Preparation |
| Control | Example 1 | Example 5 | Example 6 | Example 7 | Example 8 |

| | | | |
|---|---|---|---|
| Kind of | Casein or | Casein or | Milk protein concentrate powder |
| protein | Sodium | Sodium | |
| | caseinate | caseinate | |

Composition ratio (wt %)

| | | | | | | |
|---|---|---|---|---|---|---|
| Milk | — | 5.0 | 5.0 | 5.0 | 5.0 | 5.0 |
| Glucide | 60.5 | 56.5 | 56.0 | 55.9 | 55.5 | 55.0 |
| (low | | | | | | |
| glucide | | | | | | |
| starch | | | | | | |
| syrup) | | | | | | |
| Non-dairy | 32.0 | 31.0 | 31.0 | 31.0 | 31.0 | 31.0 |
| fat and oil | | | | | | |
| Protein | 3.5 | 3.5 | 4.0 | 4.0 | 4.0 | 4.0 |
| Emulsifier | 1.5 | 1.5 | 1.5 | 1.5 | 1.5 | 1.5 |
| Phosphate | 2.5 | 2.5 | 2.5 | 2.5 | 2.5 | 2.5 |
| Milk | — | — | — | 0.1 | 0.5 | 1.0 |
| calcium | | | | | | |

pH, buffer capacity, feathering rate and flavor and taste of milk

| | | | | | | |
|---|---|---|---|---|---|---|
| pH | 8.0 | 7.9 | 7.6 | 7.6 | 7.9 | 8.0 |
| Buffer | 9.2 | 9.0 | 8.4 | 8.6 | 9.0 | 9.2 |
| capacity | | | | | | |
| (ml) | | | | | | |
| Feathering | 1 | 2 | 4 | 3 | 2 | 2 |
| rate | | | | | | |
| Flavor and | 7.5 | 10.5 | 10.5 | 11.0 | 11.5 | 12.0 |
| taste of | | | | | | |
| milk | | | | | | |

TABLE 7
pH, buffer capacity, feathering rate and flavor and taste of milk of skim milk-
containing non-dairy coffee creamer with varying milk calcium content

| | | | Preparation | Preparation | Preparation |
|---|---|---|---|---|---|
| | Comparative | Preparation | Example | Example | Example |
| Control | Example 2 | Example 9 | 10 | 11 | 12 |

| | | | |
|---|---|---|---|
| Kind of | Casein or | Casein or | Milk protein concentrate powder |
| protein | Sodium | Sodium | |
| | caseinate | caseinate | |

Composition ratio (wt %)

| | | | | | | |
|---|---|---|---|---|---|---|
| Skim milk | — | 4.0 | 4.0 | 4.0 | 4.0 | 4.0 |
| Glucide | 60.5 | 56.5 | 56.0 | 55.9 | 55.5 | 55.0 |
| (low DE | | | | | | |
| glucide | | | | | | |
| starch | | | | | | |
| syrup) | | | | | | |
| Non-dairy | 32.0 | 32.0 | 32.0 | 32.0 | 32.0 | 32.0 |
| fat and oil | | | | | | |
| Protein | 3.5 | 3.5 | 4.0 | 4.0 | 4.0 | 4.0 |
| Emulsifier | 1.5 | 1.5 | 1.5 | 1.5 | 1.5 | 1.5 |
| Phosphate | 2.5 | 2.5 | 2.5 | 2.5 | 2.5 | 2.5 |
| Milk | — | — | — | 0.1 | 0.5 | 1.0 |
| calcium | | | | | | |

pH, buffer capacity, feathering rate and flavor and taste of milk

| | | | | | | |
|---|---|---|---|---|---|---|
| pH | 8.0 | 8.1 | 7.8 | 7.8 | 8.0 | 8.2 |
| Buffer | 9.2 | 9.0 | 8.6 | 8.6 | 9.2 | 9.5 |
| capacity (ml) | | | | | | |
| Feathering | 1 | 2 | 4 | 3 | 2 | 2 |
| rate | | | | | | |
| Flavor and | 7.5 | 9.8 | 10.0 | 10.5 | 11.5 | 12.0 |
| taste of | | | | | | |
| milk | | | | | | |

As shown in Tables 6 and 7, a non-dairy coffee creamer according to an embodiment of the present invention has a varying feathering rate according to the milk calcium content. Overall, when 0.5 wt % or more of milk calcium was added to the non-dairy coffee creamer including a milk protein concentrate powder, a non-dairy coffee creamer composition with stability in feathering was able to be prepared.

Accordingly, like Preparation Example 7, Preparation Example 8, Preparation Example 11, and Preparation Example 12, non-dairy coffee creamers containing milk or skim milk and milk protein concentrate powder had typically desired qualities of non-dairy coffee creamer when the milk calcium content is 0.5 wt % or more.

Based on these example results described above, an optimal production method for non-dairy coffee creamer that contains milk or skim milk, does not contain casein or sodium caseinate, and has stability in feathering is presented below.

### Preparation Example 13

### Production of Milk or Skim Milk-Containing Non-Dairy Coffee Creamer with Stability in Feathering

Milk or skim milk was sterilized (at a temperature of 130 to 150° C. for 0.5 seconds to 5 seconds), and then cooled to a temperature of 10° C. or lower. The cooled milk or skim milk was pre-heated to a temperature of 90° C. and then vacuum evaporated with a vacuum pressure of −0.7 to −0.9 bar until a concentration of dissolved oxygen was 1.0 ppm. The evaporated milk was pre-heated to a temperature of 40 to 70° C., and then, at a vacuum pressure of −0.3 to −0.7 bar, 4 to 5 wt % of the pre-heated evaporated milk was mixed with 55˜55.5 wt % of starch syrup, 31 to 32 wt % of non-dairy fat and oil, 1.5 wt % of emulsifier, 2.5 wt % of phosphate, 4 wt % of milk protein concentrate powder, and 0.5˜1.0 wt % of milk calcium and the mixture was homogenized to prepare a homogenized mixture. The prepared homogenized mixture was dried by using a dryer with a blasting temperature of 150° C. to complete the production of non-dairy coffee creamer.

The present invention provides a non-dairy coffee creamer that uses, instead of casein or sodium caseinate which is used as an additive for a typical non-dairy coffee creamer, milk or skim milk that is not harmful for the human body, the milk protein concentrate powder and the milk calcium that is derived from safe milk to provide stability in feathering. Accordingly, the non-dairy coffee creamer matches well with coffee of, for example, a coffee mix including instant coffee and sugar and decreases a sour taste of coffee to provide the original function of the non-dairy coffee creamer.

Also, the non-dairy coffee creamer according to an embodiment of the present invention uses as a source material a evaporated milk obtained by sterilizing milk or skim milk and vacuum evaporating the sterilized milk to remove components of off-taste and off-flavor, thereby allowing production of a non-dairy coffee creamer with enhanced soft taste of milk. In particular, since the evaporated milk and a source material for non-dairy coffee creamer are mixed and homogenized under a vacuum pressure in preparing non-dairy coffee creamer, a non-dairy coffee creamer providing a soft taste may be obtained without foreign tastes of non-dairy coffee creamer.

It will be apparent to those skilled in the art that various modifications can be made to the above-described exemplary embodiments of the present invention without departing from the spirit or scope of the invention. Thus, it is intended that the present invention covers all such modifications provided that they come within the scope of the appended claims and their equivalents.

1. A method of producing non-dairy coffee creamer, the method comprising:
sterilizing milk or skim milk;
cooling the sterilized milk to obtain a cooled sterilized milk;
pre-heating and then vacuum-evaporating the cooled sterilized milk to obtain an evaporated milk;
mixing and homogenizing the evaporated milk, a source material for non-dairy coffee creamer, a milk protein concentrate powder and a milk calcium under atmospheric pressure or vacuum pressure to obtain a homogenized mixture; and
drying the homogenized mixture to produce the non-dairy coffee creamer.

2. The method of claim 1, wherein the preheating is performed at a temperature of 80 to 90° C. and the vacuum-evaporating is performed at a vacuum pressure of −0.7 to −0.9 bar until a dissolved oxygen concentration is 1.0 to 1.6 ppm.

3. The method of claim 1, wherein the mixing and homogenizing is performed by pre-heating the evaporated milk to a temperature of 40 to 70° C., and then mixing and homogenizing the source material for non-dairy coffee creamer, the milk protein concentrate powder and the milk calcium at a vacuum pressure of −0.3 to −0.7 bar.

4. The method of claim 1, wherein the source material for non-dairy coffee creamer is selected from the group consisting of glucide, non-dairy fat and oil, an emulsifier, an acidity controller, and a combination thereof.

5. The method of claim 1, wherein the milk protein concentrate powder in the homogenized mixture is in a range of 1 to 6 wt %, based on total weight of the homogenized mixture.

6. The method of claim 1, wherein the milk calcium in the homogenized mixture is in a range of 0.3 to 1.5 wt %, based on total weight of the homogenized mixture.

7. The method of claim 1, wherein the milk calcium in the homogenized mixture is greater than 0.5 wt %, based on total weight of the homogenized mixture.

8. The method of claim 1, wherein the mixing and homogenizing comprises mixing and homogenizing 4 to 5 wt % of pre-heated evaporated milk, 55 to 55.5 wt % of starch syrup, 31 to 32 wt % of non-dairy fat and oil, 1.5 wt % of emulsifier, 2.5 wt % of phosphate, 4 wt % of milk protein concentrate powder, and 0.5 to 1.0 wt % of milk calcium.

9. The method of claim 1, wherein the homogenized mixture is essentially free from casein or sodium caseinate.

10. A non-dairy coffee creamer prepared by using the method of claim 1.

11. An instant coffee mix package comprising coffee, sugar, and the non-dairy coffee creamer of claim 10.
